(19) United States
(12) Patent Application Publication
(10) Pub. No.: US 2016/0123572 A1
(43) Pub. Date: May 5, 2016

(54) LIGHT SOURCE FOR IMPROVING VISIBILITY OF A ROAD USER COMPRISING A WEARABLE ARTICLE

(71) Applicant: 4LIGHT AB, Kista (SE)

(72) Inventor: Kourosh Mohadjeri, Kista (SE)

(73) Assignee: 4LIGHT AB, Kista (SE)

(21) Appl. No.: 14/710,187

(22) Filed: May 12, 2015

(30) Foreign Application Priority Data
Nov. 3, 2014 (SE) 1400525-0
Jan. 21, 2015 (SE) 1550052-3
Mar. 30, 2015 (SE) 1550375-8

(51) Int. Cl. F21V 33/00; A41D 13/00; A45C 15/06; F21V 23/04

(52) U.S. Cl. CPC F21V 33/0004; F21V 23/04; A41D 13/0002; A45C 15/06; F21Y 2101/02

(57) ABSTRACT

The present invention relates to a light source comprising a wearable article,
one or more exchangeable light chains comprising a sequence of light sources on a longitudinal strip, and arranged on the wearable article, and
a power source for powering the light chain,
   wherein the wearable article comprises at least one elongated and closable pocket adapted to receive said one or more light chains, the pocket comprising an opening adapted for passage of the light chain in and out of the pocket and a locking member adapted to lock the opening of the pocket, and the pocket is transparent for light on a front side of the wearable article.

### FIELD OF THE INVENTION

The present invention relates to a light source for improving visibility of a road user comprising a wearable article, one or more exchangeable light chains comprising a sequence of light sources on a longitudinal strip, and arranged on the wearable article, and a power source for powering the light chain.

### BACKGROUND OF THE INVENTION

Safety on roads depends for a large part on the visibility of the road user for other drivers. Many traffic accidents occur due to poor visibility of road users for other drivers. Compared to cars, road users, such as joggers, road workers, bicyclists, bikers and all-terrain vehicles have a small profile. This makes it difficult for other drivers to notice their presence on the road. The small tail lights of bicycles, scooters and motorbikes improve the visibility but these lights become only visible at shorter distances. The number of traffic accidents could be reduced if the visibility of road users, especially those with a small profile, could be improved. Various devices have been developed to improve said visibility. An example are reflectors comprising a light reflecting material that can be attached to clothes of a road user. Another example are vests made of light reflecting material. Also known are garments like coats and trousers that comprise pieces or strips of light reflecting material sewn on or in the fabric of the garment. Policeman and fireman usually wear such garments.

The capacity of the material to reflect light is however limited in distance and intensity. The reflection of light occurs first at a relative short distance from the user of the light reflecting material. Further, dirt on the light reflecting material and wear and tear of the material severely reduce the quality of the reflection by the material.

Devices comprising light sources have also been developed. Some of the devices such as head lights are however not efficient enough to increase the profile of the user, especially not at longer distances.

U.S. 2010/0124049 describes a jacket for a motorcyclist, wherein light sources are fixedly sewn into the fabric of the jacket. A white light source is positioned on the front side of the jacket, a red light source is positioned on the back side of the jacket and orange/yellow light sources are positioned on the shoulders of the jacket. The light source comprises a light chain comprising a sequence of light sources on a longitudinal strip, which light chain is sewn in the fabric of the jacket. The power for the light may be provided by a battery connected to the jacket or by the motorcycle. The jacket may further comprise a communication unit configured to communicate with an external communication unit on the motorcycle such that the light sources in the jacket are synchronised with the lights of the motorcycle., i.e. when the left indicator is used by the motorcyclist the indicator on the motorcycle and the yellow light source on the jacket are illuminated. Although such a device improves the visibility of a motorcyclist, the jacket is expansive to manufacture. Further, the use of the jacket is limited to motorcyclists. Besides, repairing the lights is a costly and cumbersome undertaking.

### OBJECT AND SUMMARY OF THE INVENTION

It is an object of the present invention to at least partly overcome the above problems, and to provide an improved device for road users that increases their visibility.

This object is achieved by a device as defined in claim 1. The device is a light source comprising a wearable article, one or more exchangeable light chains comprising a sequence of light sources on a longitudinal strip, and arranged on the wearable article, and a power source for powering the light chain. The light source is characterized in that the wearable article comprises at least one elongated and closable pocket adapted to receive said one or more light chains. The pocket comprises an opening adapted for passage of the light chain in and out of the pocket. The pocket further comprises a locking member adapted to lock the opening of the pocket. The pocket is transparent for light on a front side of the wearable article.

According to an embodiment of the invention, the wearable article comprises two or more straps and at least two of the straps comprise said pockets

The object is also achieved by a light source according to claim 2, comprising
at least one individual connectable strap configured to assemble the wearable article,
one or more exchangeable light chains comprising a sequence of light sources on a longitudinal strip and arranged on the straps, and
a power source for powering the light chain,
   wherein each strap comprises opening means adapted to connect to another strap and at least one elongated and closable pocket adapted to receive said one or more light chains, the pocket comprising an opening adapted for passage of the light chain in and out of the pocket and a locking member adapted to lock the opening of the pocket, and the pocket is transparent for light on a front side of the wearable article.

In one embodiment, the light source comprises at least two straps.

An advantage of the wearable article according to the invention is that it can be used by all road users. Further, the article can easily be adapted to the needs of the road user. For example, a motorcyclist may use white lights on the chest and red lights on the back and yellow lights on the shoulders. If this motorcyclist is a policeman, he can easily exchange the light sources and put in blue or red warning lights used by the police. Alternatively, the policeman on his motorbike can have more than one light in the pockets and simply change the illumination of the light sources already present in the pockets. Thus, the new wearable article improves visibility of the road user in a convenient, variable and efficient manner.

When the light sources need to be repaired, the user of the article can easily open the pocket and exchange the light source. The wearable article does not need to be cut and sewed again. According to an embodiment of the invention, the wearable article is a harness or a bag, such as a hip bag or a rucksack.

According to an embodiment of the invention, the wearable article is a harness comprising:
two shoulder straps,
at least one front strap connected to the shoulder straps, and
at least one back strap connected to the shoulder straps, and whereby at least two of said straps comprise at least one of said pockets extending along a length of the strap and including at least one of said light chain.

According to a further embodiment of the invention, the wearable article is a harness or a bag and the wearable article further comprises straps without pockets.

A harness provided with light sources is easy to put on and can be worn by a user on top of any coat he may be wearing. A harness does not take much storage space and can easily be stored in a car or even a motorbike. A harness is relatively light compared to a jacket and can be worn by any user. For example, even a jogger can wear the harness on a hot summer evening. A harness is relatively easy to manufacture. The harness improves the visibility of the road user in a flexible, cost effective, convenient and efficient manner.

According to another embodiment of the invention, the locking member of the pocket is a zipper, a zip-lock or a Velcro straps. The locking member is easy to use. Preferably, the locking member provides a water tight lock. Further, the locking member can be made of material that is light in weight and durable. In one embodiment, the locking member, such as zippers, zip-locks and Velcro straps, is provided along a substantially portion of a length of the front-, back- and/or shoulder straps.

According to a further embodiment of the invention, the at least one front strap has a length that is longer than a length of the at least one back strap. An advantage of an increased length of the at least one front strap is that the light sources comprised in the front strap shines in a forward and/or downward direction, and not in a direction towards the face of the user. This prevents the user from being blinded by the light source from the front strap. This embodiment thus improves safety and convenience for the user of the wearable article or harness.

According to an embodiment of the invention, at least one of the straps comprise an opening means adapted to removably attached the strap to another strap. According to another embodiment, the at least one front strap comprises an opening means adapted to removably attached to at least one of the shoulder straps. The front straps may be attached to the shoulder straps using opening means such as press buttons or Velcro straps. Comfort for the user of the wearable article is improved if the front side of the article can be opened to put the wearable article on. The disadvantage of reflecting vests are that they are cumbersome to put on and take off, especially when they need to be worn over a coat. This embodiment also improves the safety of the user. The user wearing the article may get caught or hooked at an external object when the article gets stuck behind the object. Or a policeman wearing the article may be attacked by an offender that tries to draw the policeman by pulling the wearable article. In these cases it is desirable for the wearable article to open, at least not at a front side of the user.

According to another embodiment of the invention, the one or more exchangeable light chains have the same or different colours. According to a further embodiment of the invention, the one or more exchangeable light chains have the same or different light intensity. The wearable article can be used for many different users by simply exchanging the light colour or intensity of the light source or by adding a colour of a light source. The wearable article can be adapted to the user in an easy and flexible manner. The user of the article only needs to have one article and the light source that conforms his/her needs. There is no need to have more than one article. This advantage decreases the costs for clothing for road users, especially road workers.

According to an embodiment of the invention, the one or more exchangeable light chains comprising a sequence of LED lights. Light chains comprising LED lights are easy to produce at low costs. The colour and intensity of the light source can be adapted when LED is used as a light source.

According to another embodiment of the invention, the wearable article further comprises one or more switches adapted to influence the illumination of the one or more exchangeable light chains. Switches improve the convenience of the user of the wearable article. Switches can be used to turn the light source(s) on or off. Switches may also be used to change from one colour to another, or to change the frequency of illumination, or to change the intensity of the light.

According to a further embodiment of the invention, the wearable article further comprises a communication unit configured to communicate with an external communication unit. An advantage of communication between the units is that the illumination of the light source in the wearable article can be synchronised with lights on a motorbike. Thus, i a yellow light of an indicator illuminates on a motorbike, the light source positioned in for example the shoulder straps of the wearable article will illuminate as well. This embodiment improves the visibility of the road user and improves safety of the road user. It also increases the flexibility of the use of the wearable article. Due to smart use of data technique, different electrical circuits or platforms or data programs can be developed for different users. This way, the switches can be instructed to provide different effects, such as change of colour, or change in intensity of the light source, or change in frequency of illumination of the light source.

### BRIEF DESCRIPTION OF THE DRAWINGS

The invention will now be explained more closely by the description of different embodiments of the invention and with reference to the appended figures.

FIG. 1 shows schematically one embodiment of the invention from a front side.

FIG. 1a shows schematically the embodiment of FIG. 1 from a back side.

FIG. 1b shows a module comprising individual straps used to assemble the embodiment of FIG. 1.

FIG. 2 shows schematically one embodiment carried by a road user.

FIG. 3 shows schematically a pocket and locking member.

FIG. 4 shows schematically a pocket and another locking member.

FIG. 5 shows schematically a light chain as a sequence of light sources on a strip.

FIG. 6 shows schematically an opening means on a front strap.

FIG. 7 shows schematically a flow diagram of a digital platform of a communication unit.

FIG. 8 shows schematically a flow diagram of a digital platform of an external communication unit.

FIG. 9 shows schematically another embodiment of the invention from a front side.

FIG. 9a shows schematically the embodiment of FIG. 9 from a back side.

FIG. 10a shows schematically yet other embodiment from a perspective.

FIG. 10b shows schematically the embodiment from a left side.

FIG. 10c shows schematically the embodiment from a top side.

### DETAILED DESCRIPTION OF PREFERRED EMBODIMENTS OF THE INVENTION

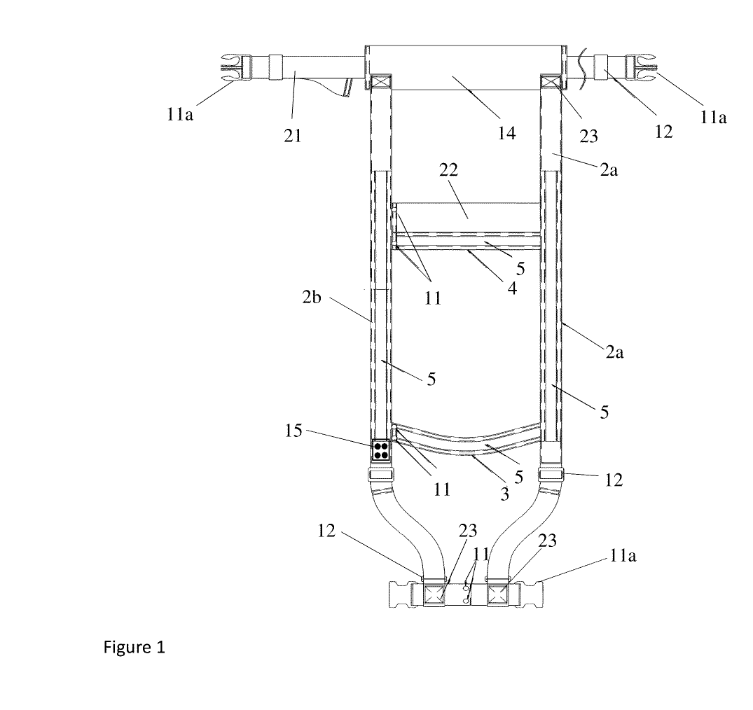

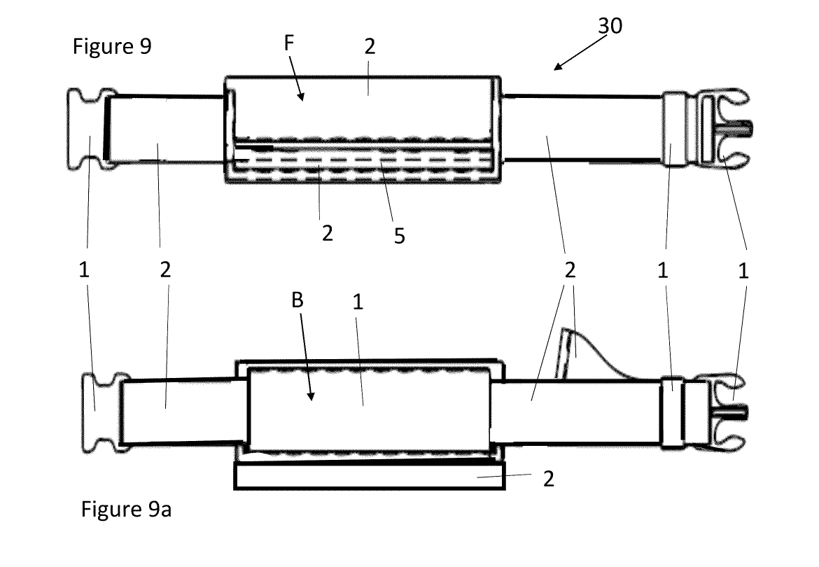

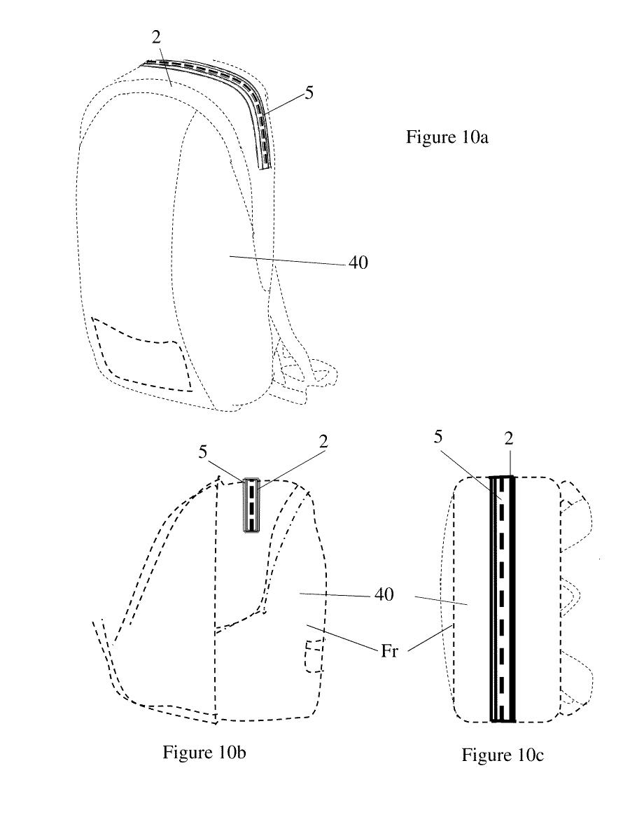

FIGS. 1, 2, 9 and 10a-c show a light source according to the invention. The light source comprises a wearable article 1. The wearable article may be any garment, bag or carrier article that can be carried by a human or animal. In FIG. 1, 1a and 2, the wearable article is a harness 1a. In FIGS. 9 and 9a, the wearable article is a bag or hip bag 30. In FIGS. 10a and 10b, the wearable article is a rucksack or backpack 40.

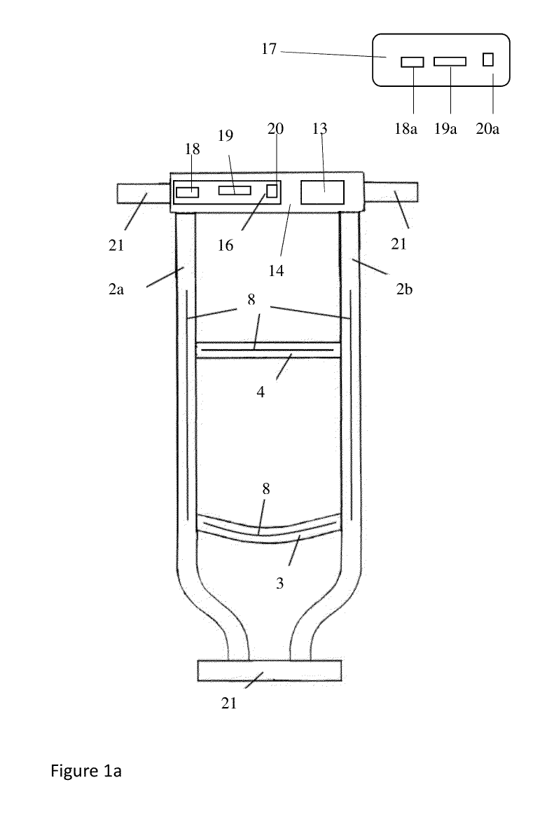

FIG. 1 shows a harness from a front side of the harness and figure la shows the back side of the harness. The harness may comprise several straps 2, 3, 4 such as two shoulder straps 2a, 2b, at least one front strap 3 connected to the shoulder straps, and at least one back strap 4 connected to the shoulder straps. The harness may have one, two, three, four or five front straps 3, and one, two, three, four or five back straps 4. It will be understood that a harness used by animals may have more or less straps depending on the size of the animal. A hip strap 21 may be used to connect the front part of the harness to the back part of the harness, as shown in FIG. 2.

The at least one front- and back strap have a length that extends between the shoulder straps. In one embodiment, the length of the at least one front strap is longer than the length of the at least one back strap. When a person wears the article around a torso of the body as shown in FIG. 2, the differences in length has the effect that the front side F of the front strap slightly faces away from the face of the person. The front strap faces down in a direction towards a spot 2 to 3 meters in front of the person carrying the article 1, i.e. at an angle between 30 to 60° in relation to a longitudinal axis Lb of the front side of the torso of the person.

FIG. 1c shows a light source comprising
individually connectable straps 2 configured to assemble the wearable article 1,
one or more exchangeable light chains 9 comprising a sequence of light sources on a longitudinal strip 10 and arranged on the straps, and
a power source 13 for powering the light chain,
   whereby the straps each comprise opening means 11 adapted to connect the straps to each other and at least one elongated and closable pocket 5 adapted to receive said one or more light chains 9, the pocket comprising an opening 7 adapted for passage of the light chain in and out of the pocket and a locking member 8 adapted to lock the opening of the pocket 5, and the pocket is transparent for light on a front side F of the wearable article 1.

The straps have a length extending along a longitudinal axis L and two ends 24. The opening means 11 may be positioned on one or on both ends of the strap. The straps are electronically connectable to each other and to a power source. One of the straps may be a hip strap 21. One of the straps may be a power strap 14. The straps may be provided in different sizes. The individual connectable straps 2 allow the user to assemble any wearable article. FIG. 1c shows straps that can be connected to assemble a harness. Other examples may be a hip bag 30 (FIG. 9). The use of individual connectable straps allows for adjustment of the size of the wearable article to the user and thus improves the flexibility of use of the light source.

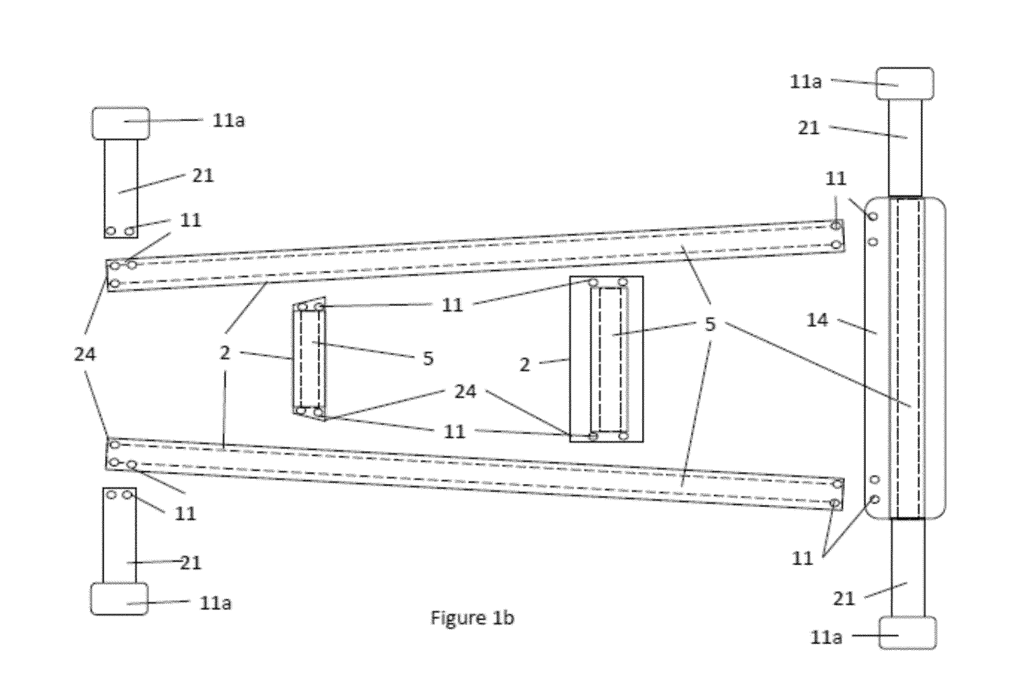

The straps 2, 2a, 2b, 3, 4 comprise pockets 5. The hip strap 21 may also comprise a pocket. The pockets extend along a length of the strap 2, 2a, 2b, 3, 4. FIG. 3 shows strap 2 comprising the pocket. The pocket is transparent for light on the front side F of the wearable article. Transparent plastic 6 can be used for this purpose. The transparent material is preferably able to withstand wear and tear. The material also is preferably not sensitive to changes in temperature. The transparent material can suitably be used in surroundings having a temperature between −50 and +60° C. The transparent material is preferably also insensitive to damage from ultra violet light. The back side B of the pocket may be transparent. Preferably, the back side of the pocket is made of the same material as the rest of the wearable article.

In FIGS. 9, 9a and 10a, the strap 2 is positioned on the bag 30, 40. The strap may be sown in or on the bag. One or more straps 2 may be positioned on the bags. In FIG. 9, a strap is positioned on a front side F of a hip bag 30. In FIG. 10a, a strap is positioned on a top side of the rucksack 40. Further straps can be positioned on the sides or the front side Fr of the rucksack.

This fabric of the wearable article is preferably durable, able to withstand changes in temperature, insensitive to dirt and water tight or water proof. Examples of such fabric may be denier cordura or ballistic nylon, or x-pac, or recycled plastics, or canvas.

The pocket 5 comprises and opening 7 adapted for passage of a light chain 9 in and out of the pocket. The pocket 5 can be closed and opened using a locking member 8. FIGS. 3a and 3c illustrate a locking member 8 positioned on the front side F of the wearable article. An example of such a locking member may be a zipper, a Velcro straps or a Zip-lock. FIG. 3a shows a front side of a Velcro lock, which may have an even surface. FIGS. 3b and 3c show a cross section A-A′ of the strap of FIG. 3a. FIG. 3c shows a back side of a Velcro lock, whereby the hooks of the Velcro material are illustrated with dots.

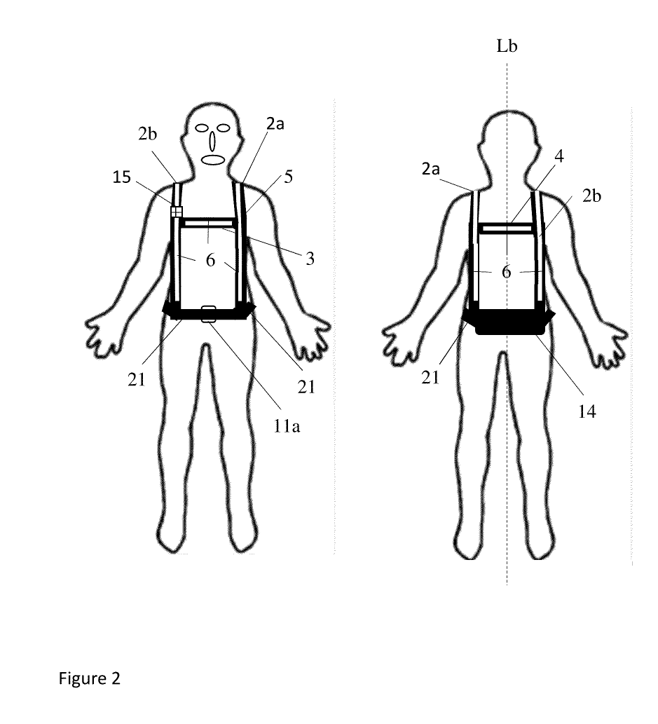

FIGS. 1a, 4 illustrates a locking member 8 positioned on the back side B of the strap 2a, 2b, 3, 4. FIG. 4b shows a cross section A-A′ of the strap of FIG. 4a. An example of such a locking member may be a zipper, a zip-lock or Velcro straps. An advantage of a zipper is that these are durable, rather insensitive to dirt and easy to use. Zippers, zip-locks or Velcro straps can easily be sewed into the fabric of the wearable article. The locking member 8, such as zippers, zip-locks and Velcro straps, can be provided along a substantially portion of a length of the strap, e.g. between 10 to 90%, or 25%, 50%, or 75% of the length of the strap 2a, 2b, 3, 4. This improves comfort and efficiency for the user of the wearable article when exchanging a light chain 9. Preferably, the locking member 8 provides a water tight and dust tight locking of the pocket 5. More preferably, the locking member 8 provides a water proof and dust tight locking of the pocket 5.

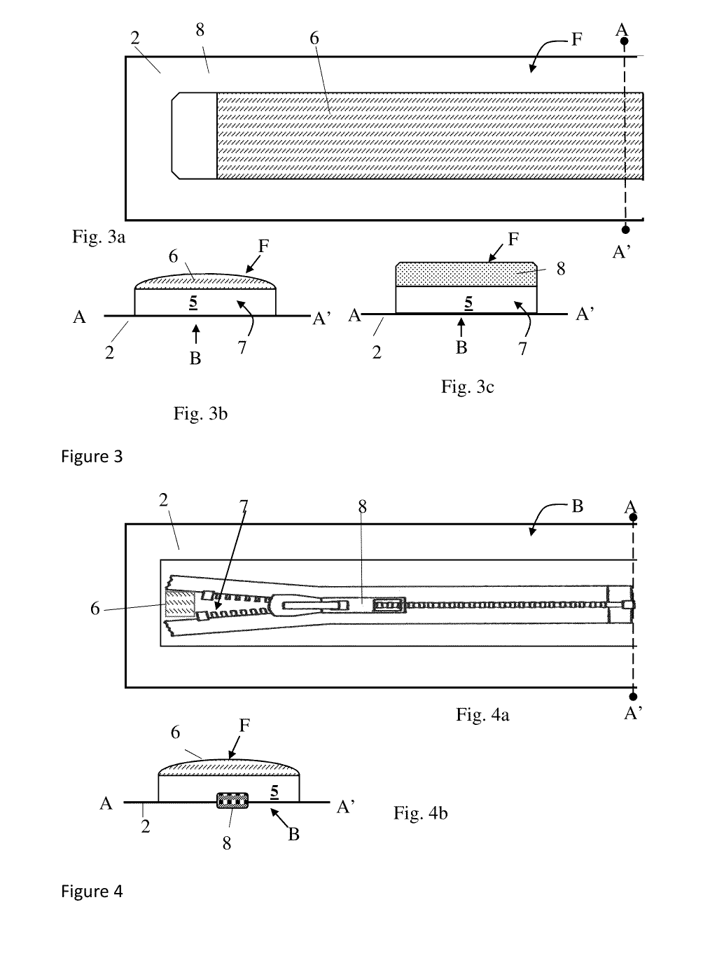

The pockets are adapted to comprise one or more light sources. The light source may be a light chain 9 comprising a sequence of light sources 9a on a longitudinal strip 10. FIG. 5 illustrates such a light chain positioned in a pocket 5. The transparent plastic window 6 is not shown in FIG. 5. Any light source can be used for the purpose of the invention. Conveniently, readily available LED light are used such that the light chain comprises a sequence of LED lights. The light may be provided and configured to be used in different colours and/or different intensities. The pocket 5 may comprise one two, three, or more light chains 9. The straps 2 comprise at least one light chain. At least two of said straps 2a, 2b, 3, 4 comprise at least one of said pockets 5 extending along a length of the strap and including at least one of said light chains 9. In one embodiment, all straps 2a, 2b, 3, 4 comprise one pocket 5, whereby each pocket comprises one or two light chains. The one or more exchangeable light chains have the same or different colours and/or the same or different light intensity.

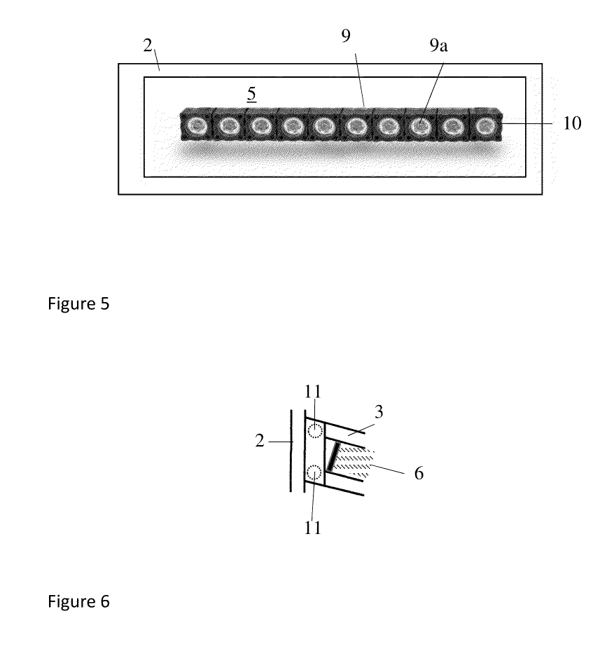

FIG. 6 shows an opening means 11 positioned on the straps 2 and on the at least one front strap 3. The opening means may be any means adapted for removing and fastening the straps. The opening means is preferably adapted to quickly and easily remove and fasten the front strap 3 off and on the shoulder strap 2. The same opening means may be present on the hip strap 21 as shown in FIG. 2. As shown in figure lb, each strap 2 may comprise opening means at both ends 24 of each strap 2. Press buttons or Velcro straps may be used as opening means. In one embodiment, press buttons are used. These buttons are less vulnerable to wear and tear, especially dirt and water. The at least one front- and back strap may both be connected to the shoulder straps using removable opening means. Alternatively, the back strap 4 may be fixedly attached to the shoulder straps 2a and 2b, and the front strap may be removably connected to one or to both shoulder straps. In one embodiment, the at least one back strap 4 is fixedly attached to the shoulder straps 2a and 2b and the at least one front strap 3 is removably connected with one shoulder strap and fixedly attached to the other shoulder strap. The shoulder straps may be fixedly attached to the front- and back straps using one or more seams 23. The shoulder straps may be fixedly attached to the hip straps 21 using one or more seams 23. The article 1 may comprise one or more opening members 11a for connecting the shoulder straps 2a, 2b at a lower side of the torso as shown in FIG. 2a. One or more opening members 11a are connected to the wearable article using for example a hip strap 21. The wearable article 1 may further comprise size adjustable means 12 adapted to adjust the size of the strap or article.

The wearable article further comprises a power source 13 for powering the light source 9. The power source may be positioned in a power strap 14 that is preferably positioned on the back of the user. The power strap may be the hip strap 21. In FIG. 9, 9a, 10a the power source is positioned in the bag. Preferably, this power strap is water tight or water proof. The power source may be a battery or a sequence of batteries. The batteries are preferably reloadable. Examples of suitable batteries are lithium-ion batteries. The output load of the power source may be about 12 direct current voltage (DCV) or about 3.7 DCV. The power handling may be about 25 Watts. The power source conveniently comprises a connection (not shown) for charging the batteries. The same connection may be used to connect the wearable article to a vehicle, such as a motorbike to establish a wired connection. The power source may further comprise battery level indicator and/or a battery charging timer with an indicator (e.g. a green lights indicating charged batteries, a yellow lights indicating that the batteries soon need to be charged and/or a red lights indicating that the batteries need to be charged) (not shown). The power strap 14 may further comprise soft material adapted to prevent the power source from being damaged. The soft material may also be used to add comfort to the back of the person wearing the article 1. Examples of soft material may be foam or padded fabric (not shown). The power strap 14 may be designed as a pocket adapted to hold the power source. The wearable article of the invention is preferably adapted for a wireless connection with an external object. As shown in FIG. 1a, such connection can be established through a communication unit 16 configured to communicate with an external communication unit 17 on the external object, such as a motor bike. For this purpose, the wearable article 1 may be provided with a computing unit or a micropoint control unit (MCU) 18, which may comprise a processor 19 and a memory 20. The computing unit 18 may be stored in the power strap 14. Wireless communication may be established using radio frequencies, Bluetooth, and the like. For this communication, the external communication unit 17 may also comprise a computing unit or a micropoint control unit (MCU) 18a, which may comprise a processor 19a and a memory 20a.

The communication unit 16 may further comprise one or more switches 15 adapted to handle and to turn off or on the one or more exchangeable light chains 9 (FIG. 1). One switch may be a main switch to turn the power provided by the power source on or off. The switches are preferably positioned on the front side of the article 1, most preferably on the shoulder straps 2a and/or 2b, such that the user of the article can easily and conveniently handle the switches. The switches may be push-button switches. The switches are connected to the light chains and the communication unit 16 through electrical cables (not shown).

A micropoint control unit (MCU) based system can be used to control the light sources in the article 1. The MCU may comprise options like battery watch systems as explained above, a

Pulse Width Modulation (PWM) with dimming functionalities for the light sources, a twinkling system with illumination frequency control and preferably with individual adjustment of the individual light sources 9a, a Bluetooth connectivity and a USB handling and charging possibility.

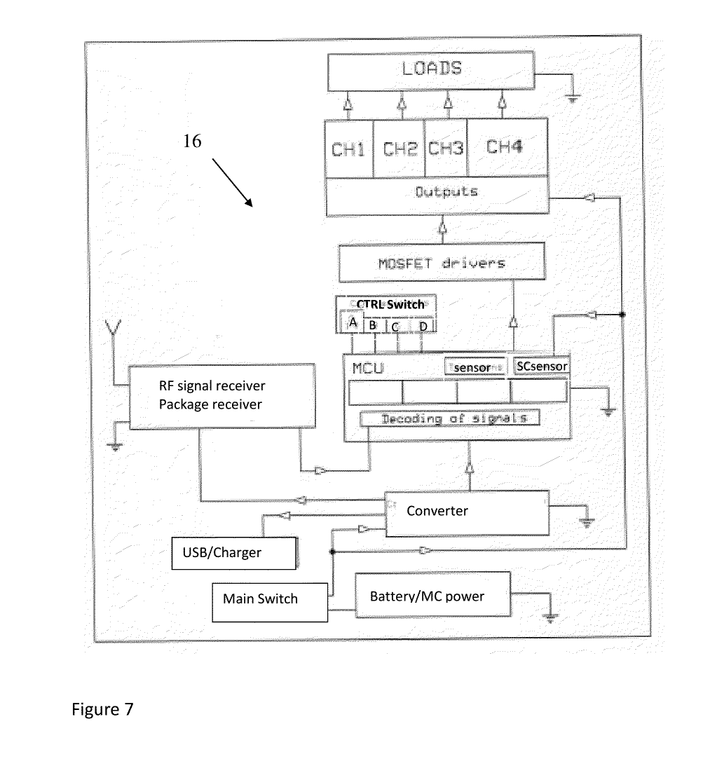

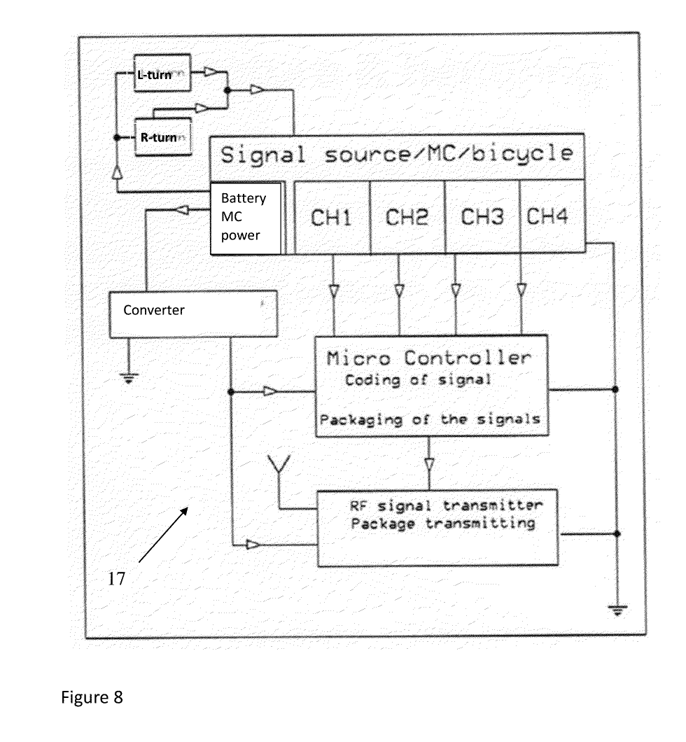

An example of an MCU based system may be a digital platform as shown schematically in FIG. 7 for the communication unit 16 and in FIG. 8 for the external communication unit 17. Positioning the main switch to an ON mode will activate the electrical functionality of the communication unit 16 and put it in a STANDBY mode and makes it ready for receiving commandos from the four switches. The four switches may be positioned in a small pocket located on the shoulder strap 2a. The four switches CH1, CH2, CH3, CH4 may be mounted on a printed circuit board (PCB). The switches may be push-button switches, e.g. of an IP67 type, which are connected to a main PCB of the communication unit with an electrical cable. The main PCB preferably also comprises the battery level indicator and battery charge timer and short circuit (SC) sensor for the LED lights. Also, MOSFET drivers (a specific type of metal oxide semiconductor field-effect transistor) and SC sensors may be used for handling the output stages of the light sources.

Pushing and holding a first switch CH1 for about 2 seconds may turn the digital platform to the ON mode and ready to use. Pushing and holding the first switch for about 2 seconds may turn the digital platform to an OFF mode. Pushing and holding a second switch CH2 for about 2 seconds may activate a particular light source, e.g. a light source positioned in the pockets 5 of the shoulder straps 2a, 2b. Pushing and holding the second switch again may allow dimming of the light. This looping cycle allows to increase or reduce the intensity of the light by pushing and holding the second switch. Pushing and holding the second switch for about 4 seconds or longer may turn the lights in the OFF mode. Pushing and holding a third switch CH3 for about 4 seconds may increase or reduce the twinkling frequencies of the light. Pushing and holding a fourth switch CH4 for about 4 seconds may activate another particular light source, e.g. a light source positioned in the pocket 5 of the front- and/or back strap 3, 4. Pushing and holding the fourth switch again may allow dimming of the light. This looping cycle allows to increase or reduce the intensity of the light by pushing and holding the fourth switch. Pushing and holding the fourth switch for about 4 seconds or longer may turn the lights in the OFF mode.

The communication unit 16 may be connected to an external communication unit 17 using Bluetooth to transmit the signals between an external object, such as a motorbike, to the wearable article 1. The external communication unit may comprise reloadable batteries and a main switch. The external unit may comprise further switches CH1, CH2 for handling the unit and for communication with the communication unit 16 on the article. A first switch CH1 may be pushed and hold for about 2 seconds to turn the digital platform in an ON mode and ready to use. Pushing and holding the switch for about 2 seconds may turn the platform in the OFF mode. Pushing and holding the first switch for about 8 seconds may turn on all the lights on the wearable article. This embodiment can be used to put on or off all the lights in a warning mode. As explained above, the different switches may have different functionalities, which can be adapted to the need of the user of the wearable article 1.

The present invention is not limited to the embodiments disclosed but may be varied and modified within the scope of the following claims. For example, the communication units may comprise an analogue platform instead of a digital platform. The communication unit 16 may comprise other functionalities such as GPS. The communication unit 16 may be connected to a server. Control or surveillance of the communication unit 16 may be performed on an Application (APP) present on a computer unit, such as a computer or mobile phone, and connected to the same server. The wearable harness may further comprise an additional piece of fabric 22 attached to the back strap 4 and extending towards the power source 13 as shown in FIG. 1. The piece of fabric can be used for texting of names, or functions of the road users.

| Reference number | feature |
|---|---|
| 1 | Wearable article, |
| 1a | Harness |
| 2 | Strap |
| 2a, 2b | Shoulder straps |
| 3 | Front strap |
| 4 | Back strap |
| 5 | Pocket |
| 6 | Transparent plastic |
| 7 | Opening in pocket |
| 8 | Locking member |
| 9 | Light chain |
| 9a | Light source |
| 10 | Strip |
| 11 | Opening means |
| 11a | Opening member |
| 12 | Size adjustable means |
| 13 | Power source |
| 14 | Power strap |
| 15 | Switch |
| 16 | Communication unit |
| 17 | External computer unit |
| 18, 18a | Computing unit |
| 19, 19a | Processor |
| 20, 20a | Memory |
| 21 | Hip strap |
| 22 | Additional piece of fabric |
| 23 | Seam |
| 24 | End of strap |
| 30 | Hip back |
| 40 | Rucksack |
| F | Front side |
| Fr | Front side of rucksack |
| B | Back side |
| L | Longitudinal axis strap |
| Lb | Longitudinal axis torso |

1. A light source comprising:
a wearable article,
one or more exchangeable light chains comprising a sequence of light sources on a longitudinal strip, and arranged on the wearable article, and
a power source for powering the light chain,
wherein the wearable article comprises at least one elongated and closable pocket adapted to receive said one or more light chains, the pocket comprising an opening adapted for passage of the light chain in and out of the pocket and a locking member adapted to lock the opening of the pocket, and the pocket is transparent for light on a front side of the wearable article.

2. A light source according to claim 1, wherein the wearable article comprises two or more straps and at least two of the straps comprise said pockets.

3. A light source comprising
one or more individual connectable straps configured to assemble a wearable article,
one or more exchangeable light chains comprising a sequence of light sources on a longitudinal strip and arranged on the straps, and
a power source for powering the light chain,
wherein each strap comprises opening means adapted to connect to another strap and at least one elongated and closable pocket adapted to receive said one or more light chains, the pocket comprising an opening adapted for passage of the light chain in and out of the pocket and a locking member adapted to lock the opening of the pocket, and the pocket is transparent for light on a front side of the wearable article.

4. A light source according to claim 3, wherein the light source comprises at least two straps.

5. A light source according to claim 1, wherein the wearable article is a harness comprising:
two shoulder straps,
at least one front strap connected to the shoulder straps, and
at least one back strap connected to the shoulder straps, and whereby at least two of said straps comprise at least one of said pockets extending along a length of the strap and including at least one of said light chain.

6. The light source according to claim 5, whereby the at least one front strap has a length that is longer than a length of the at least one back strap.

7. The light source according to claim 1, wherein the wearable article is a harness or a bag.

8. The light source according to claim 1, wherein the bag is a hip bag or a rucksack.

9. The light source according to claim 1, wherein the wearable article is a harness or a bag and the wearable article further comprises straps without pockets.

10. The light source according to claim 1, whereby the locking member of the pocket is a zipper, a zip-lock or a Velcro strap.

11. (canceled)

12. The light source according to claim 1, whereby at least one of the straps comprise an opening means adapted to removably attach the strap to another strap.

13. The light source according to claim 1, whereby the one or more exchangeable light chains have the same or different colours.

14. The light chain according to claim 1, whereby the one or more exchangeable light chains have the same or different light intensity.

15. The light source according to claim 1, whereby the one or more exchangeable light chains comprising a sequence of LED lights.

16. The light source according to claim 1, whereby the wearable article further comprises one or more switches adapted to influence the illumination of the one or more exchangeable light chains.

17. The light source according to claim 1, whereby the wearable article further comprises a communication unit configured to communicate with an external communication unit.

18. A light source according to claim 1, wherein the wearable article is a harness comprising:
two shoulder straps,
at least one front strap connected to the shoulder straps, and
at least one back strap connected to the shoulder straps, and whereby at least two of said straps comprise at least one of said pockets extending along a length of the strap and including at least one of said light chain.

19. The light source according to claim 1, wherein the wearable article is a harness or a bag.

20. The light source according to claim 1, wherein the locking member of the pocket is a zipper, a zip-lock or a Velcro strap.

21. The light source according to claim 1, wherein the one or more exchangeable light chains have the same or different colours.
